(19) United States
(12) Patent Application Publication
(10) Pub. No.: US 2016/0055985 A1
(43) Pub. Date: Feb. 25, 2016

(54) CIRCUIT BREAKERS, CIRCUIT BREAKER LINE POWER ASSEMBLIES, AND OPERATIONAL METHODS

(71) Applicant: Siemens Industry, Inc., Alpharetta, GA (US)

(72) Inventors: Russell Thomas Watford, Lawrenceville, GA (US); Brian Timothy McCoy, Lawrenceville, GA (US)

(21) Appl. No.: 14/467,128

(22) Filed: Aug. 25, 2014

(51) Int. Cl. H01H 1/58

(52) U.S. Cl. CPC H01H 1/58

(57) ABSTRACT

Circuit breaker line power assemblies having a line terminal, a stationary contact terminal, and a line conductor extending from the line terminal to the stationary contact terminal including braided strand construction are disclosed. According to another aspect, circuit breakers including circuit breaker line power assemblies and methods of operating circuit breaker line power assemblies are provided, as are other aspects.

### FIELD

Embodiments of the present invention relate generally to circuit breakers, and more particularly to power wire assemblies and components for circuit breakers.

### BACKGROUND

In general, a circuit breaker operates to engage and disengage a selected electrical circuit from an electrical power supply. The circuit breaker ensures current interruption thereby providing protection from continuous over-current conditions and high current transients due to electrical short circuits. Such circuit breakers operate by separating a pair of internal electrical contacts contained within a housing of the circuit breaker. Typically, one electrical contact is stationary while the other is movable. Conventional circuit breakers include a moving electrical contact mounted on an end of a pivotable contact arm, such that the moving electrical contact moves through an arc-shaped motion path. Contact separation between the moving and stationary contacts may occur manually, such as by a person throwing a circuit breaker handle. This may engage a trip mechanism, which may be coupled to the contact arm and the moveable contact. Otherwise, the electrical contacts may be separated automatically when an over-current or short-circuit condition is encountered. This automatic tripping may be accomplished by a tripping mechanism actuated via a thermal overload element (e.g., a bimetal element) or by an actuator element (e.g., an electromagnetic actuator). There is a push in the industry to increase the handle rating of circuit breakers, while at the same time, keeping the housing dimensions constant. This presents numerous problems to be explained further herein.

Accordingly, it may be beneficial to provide circuit breaker apparatus, and circuit breaker components and assemblies that can accommodate higher handle ratings while keeping the size of the circuit breaker housing the same as previous circuit breakers.

### SUMMARY

According to a first aspect, a circuit breaker line power assembly is provided. The circuit breaker line power assembly includes a line terminal, a stationary contact terminal, and a line conductor extending from the line terminal to the stationary contact terminal, wherein the line conductor comprises braided strand construction.

In accordance with another aspect, a circuit breaker is provided. The circuit breaker includes a housing including a pocket, and a circuit breaker line power assembly including a line terminal, a stationary contact terminal received in the pocket, and a line conductor extending from the line terminal to the stationary contact terminal, wherein the line conductor comprises braided strand construction.

In accordance with another aspect, a method of operating a circuit breaker is provided. The method includes providing circuit breaker line power assembly including a line terminal, a stationary contact terminal, and line conductor comprising braided strand construction extending from the line terminal to the stationary contact terminal, and passing electrical current through the line conductor of the circuit breaker line power assembly.

Still other aspects, features, and advantages of the present invention may be readily apparent from the following detailed description by illustrating a number of example embodiments and implementations, including the best mode contemplated for carrying out the present invention. The present invention may also be capable of other and different embodiments, and its several details may be modified in various respects, all without departing from the scope of the present invention. Accordingly, the drawings and descriptions are to be regarded as illustrative in nature, and not as restrictive. The invention is to cover all modifications, equivalents, and alternatives falling within the scope of the invention.

### BRIEF DESCRIPTION OF DRAWINGS

The drawings, described below, are for illustrative purposes only and are not necessarily drawn to scale. The drawings are not intended to limit the scope of the invention in any way.

FIG. 1A illustrates a first perspective view of a circuit breaker power wire assembly according to embodiments.

FIG. 1B illustrates a second perspective view of a circuit breaker power wire assembly according to embodiments.

FIG. 1C illustrates a first side plan view of a conductor comprising braided construction of a circuit breaker power wire assembly according to embodiments.

FIG. 1D illustrates a second side plan view of a conductor comprising braided construction of a circuit breaker power wire assembly rotated 90 degrees from FIG. 1C according to embodiments.

FIG. 1E illustrates an enlarged view of woven construction of an insulation of a circuit breaker power wire assembly according to embodiments.

FIG. 1F illustrates a perspective view of a stationary contact terminal of a circuit breaker power wire assembly according to embodiments.

FIG. 2A illustrates a first perspective view of a circuit breaker power wire assembly of a two-pole circuit breaker according to embodiments.

FIG. 2B illustrates a second perspective view of a circuit breaker power wire assembly of a two-pole circuit breaker according to embodiments.

FIG. 3A illustrates a first perspective view of a circuit breaker power wire assembly for a two-pole circuit breaker including bolt-on line terminals according to embodiments.

FIG. 3B illustrates a second perspective view of a circuit breaker power wire assembly for a two-pole circuit breaker including bolt-on line terminals according to embodiments.

FIG. 4A illustrates a side plan view of a housing of a circuit breaker including a circuit breaker power wire assembly installed therein according to embodiments.

FIG. 4B illustrates a partial cross-sectioned side view of stationary contact terminals of a circuit breaker power wire assembly shown installed in a housing of a circuit breaker according to embodiments.

FIG. 5 illustrates a flowchart of a method of operating a circuit breaker line power assembly according to embodiments.

### DESCRIPTION

Reference will now be made in detail to the example embodiments of this disclosure, which are illustrated in the accompanying drawings. Wherever possible, the same reference numbers will be used throughout the drawings to refer to the same or like parts throughout the several views. Features of the various embodiments described herein may be combined with each other, unless specifically noted otherwise.

In view of the above-described direction in the industry to increase the handle rating of certain circuit breakers (e.g., residential circuit breakers) to 40 A, 50 A, or even 60 A, while at the same time maintaining a size of the circuit breaker housing (molded case) at the same dimensions of lower rated circuit breakers, several problems have been encountered.

First, to accommodate these higher handle ratings, the size of the power line may be increased. However, when line size was increased using exiting conventional technology (twisted strand 16 gauge copper wire with fluoro-ethylene polymer insulation), it was discovered that using such conventional power line designs and components becomes unwieldy. In particular, it is very difficult to manipulate and bend conventional power lines within the small space constraints that are provided. In another aspect, the higher handle ratings result in higher currents and more arc debris and arcing that may potentially harm internal components. Furthermore, higher handle ratings include stiffer springs resulting in higher loads on the stationary contact terminal.

To overcome the foregoing difficulties and provide a suitably-sized power conductor within the space constraints available, a novel construction of circuit breaker line power assembly is provided. Therefore, according to one or more embodiments of the invention, a circuit breaker line power assembly including improved flexibility is provided. In another aspect, an improved stationary contact terminal construction is provided. These aspects may be used together in some embodiments.

The circuit breaker line power assembly includes a line terminal, a stationary contact terminal, and a line conductor extending from the line terminal to the stationary contact terminal, wherein the line conductor comprises braided strand construction. The line conductor may also include a woven insulation, such as woven fiberglass insulation. In another aspect, a novel stationary contact construction allows fewer bends of the line conductor and also allows firm installation in the housing of the circuit breaker.

The principles of the present invention are not limited to the illustrative examples depicted herein, but may be applied and utilized in any type of circuit breaker, either mechanical or electronic, such as single-pole circuit breakers, duplex circuit breakers, two-pole circuit breakers, multi-pole circuit breakers, ground fault circuit interrupters (GFCI), arc fault circuit interrupters (AFCI), surge protective devices (TVSS), metering circuit breakers, electronic trip unit breakers, or remotely-controllable circuit breakers where higher handle ratings are sought within an existing standard housing space envelope.

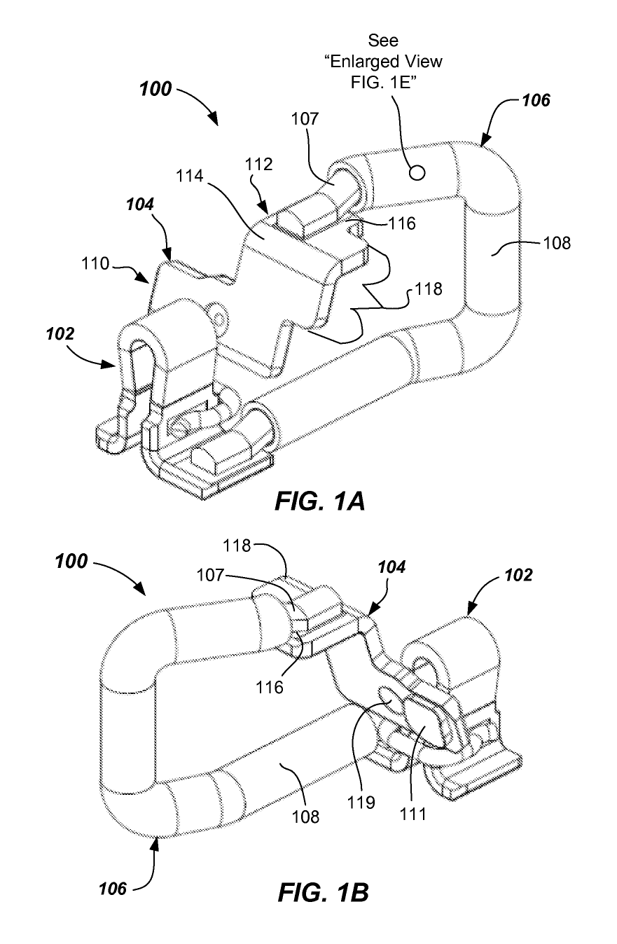

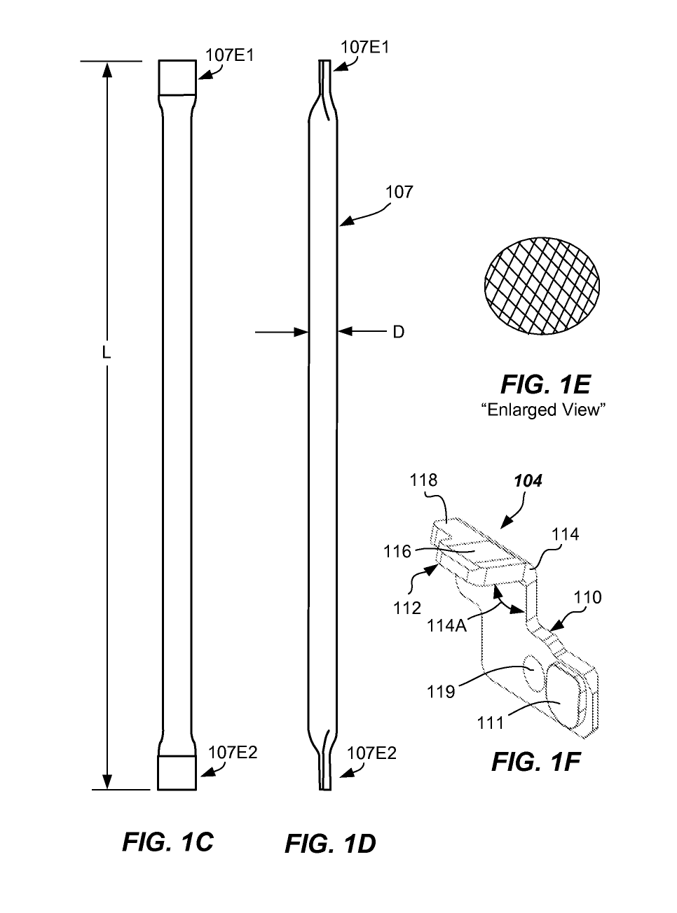

These and other embodiments of the circuit breaker power line assemblies, circuit breakers containing the circuit breaker power line assemblies and methods of operating the circuit breaker power line assemblies according to the present invention are described below with reference to FIGS. 1A-5.

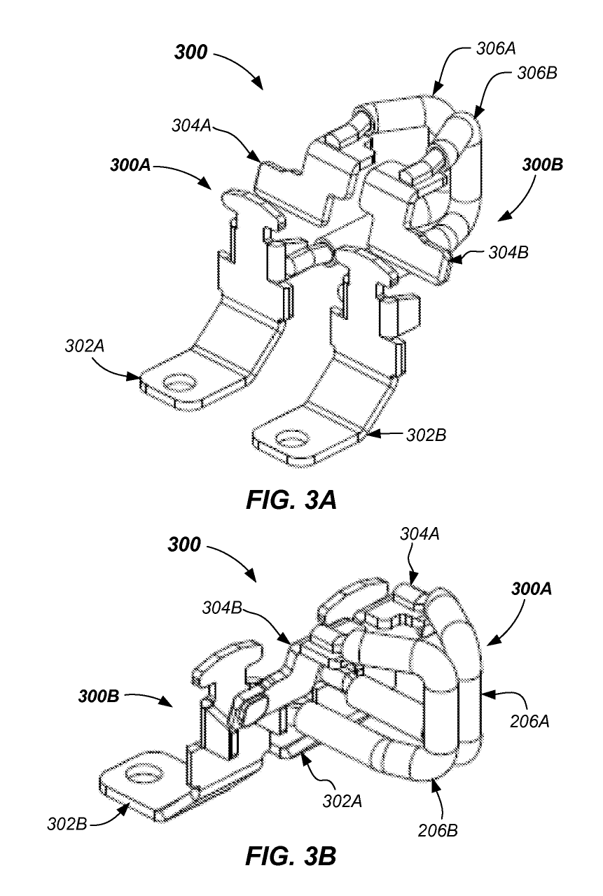

Referring now to FIGS. 1A-1F, various views of a circuit breaker line power assembly 100 and components thereof in accordance with embodiments of the invention are illustratively shown. Circuit breaker line power assembly 100 includes a line terminal 102, a stationary contact terminal 104, and a line conductor 106 extending from the line terminal 102 to the stationary contact terminal 104. The line conductor 106 is electrically attached to the line terminal 102 and the stationary contact terminal 104 at terminal ends thereof. Attachment may be performed by resistive welding, as is conventional. The line terminal 102 may comprise a c-clip (FIGS. 1A-1B) or a bolt-on terminal connector (FIGS. 3A-3B). Other suitable line terminal configurations may be used.

In accordance with embodiments of the invention, the line conductor 106 comprises braided strand construction. In the depicted embodiment, the line conductor 106 may comprise a conductor 107 and a sleeve of insulation 108, which may comprise a woven sleeve of insulation, such as woven fiberglass insulation (See “Enlarged View” of FIG. 1E illustrating the woven condition of the sleeve of insulation 108). In some embodiments, the insulation 108 includes a woven fiberglass insulating sleeve extending along substantially an entire length of the conductor 107, except for at the attached ends thereof. In some embodiments, the insulation 108 of the line conductor 106 may comprises an acrylic coating. One particularly effective embodiment includes an acrylic-coated, woven fiberglass insulating sleeve. The insulation 108 may be a finely braided fiberglass sleeve with a di-electric film of acrylic resin applied thereto.

In more detail, the conductor 107 of the line conductor 106 comprises braided strand construction. Braided strand construction, as used herein, means interweaving strands of wire arranged in a diagonally overlapping pattern. The braided strand construction of the conductor 107 may include multiple strands of copper wire that are braided. Each of the strands may be copper wire having a diameter of greater than about 0.0015 inch (about 0.038 mm), and in some embodiment a diameter of between about 0.0015 inch (about 0.038 mm) and about 0.0025 inch (about 0.064 mm). Size #44 copper wires may be used in one or more embodiments.

In some embodiments, the braided strand construction of the conductor 107 may include greater than about 1,500 strands, greater than about 2,000 strands, or even greater than about 2,500 strands. In some embodiments between about 1,500 strands and about 3,000 strands. An overall conductor diameter D of the conductor 107 (FIG. 1D) may be greater than about 0.125 inch, and may be between about 0.125 inch (about 3.2 mm), and 0.150 inch (about 3.8 mm), in some embodiments.

One particularly effective configuration of conductor 107 includes braided strand construction and comprises between about 1,500 strands and about 3,000 strands of copper wire, each strand having an outer diameter of between about 0.0015 inch (about 0.038 mm) and about 0.0025 inch (about 0.064 mm), and an overall conductor diameter D of the conductor 107 of greater than about 0.125 inch (about 3.2 mm) and less than about 0.150 inch (about 3.8 mm).

In some embodiments, the braided strand construction of the conductor 107 comprises greater than 1500 strands of copper having a diameter of greater than about 0.0015 inch (about 0.038 mm), and an overall conductor diameter D of greater than about 0.125 inch (about 3.2 mm) as shown in FIG. 1D. The line conductor 106 may have a length L, as shown in FIG. 1C, of between about 2.6 inch (about 66 mm) and about 3.5 inch (about 89 mm). Other lengths L may be used.

In some embodiments, the conductor 107 of the line conductor 106 may comprise a combination of braided construction and twisted construction. For example, the conductor 107 may comprise multiple braided sub-groups, which may be twisted together. Each sub-group may comprise, for example, 35-75 strands of copper wire (e.g., #44 copper wires) that are braided together. Several of these sub-groups may then be twisted together.

For example, multiple sub-groups of braided construction may be twisted together in a first twist direction, such as with a right hand lay of the twist to construct multiple twisted bundles. Any suitable lay may be used. These twisted bundles may be annealed at a suitable annealing temperature. Multiple ones of these twisted bundles may then be twisted together in a second twisting process, such as in an opposite twist direction of that used previously. Any suitable lay may be used which may be the same or different than the lay previously used. The final twisting may be used to form the final diameter conductor diameter D of the conductor 107 (see FIG. 1D). Ends of the conductor 107 may include portions that have been compressed, or compressed and heated, to form end regions 107E1, 107E2 that are denser and configured to be attached to the respective line terminal 102 and to the line tab 116 of the stationary contact terminal 104.

The braided strand constructions described herein provide excellent flexibility and ability to accommodate 90 degree bends or more, thus allowing the line conductor 106 to be received within the very tight space environment of the housing of a circuit breaker (e.g., of a 40 A-60 A residential circuit breaker). The combination of the braided strand construction of the conductor 107 with the insulation 108 of woven fiberglass provide especially good flexibility, yet also provide adequate insulation properties for circuit breakers having 40 A-60 A handle ratings.

Again referring to FIGS. 1A-1B, and 1F, the stationary contact terminal 104 of the circuit breaker line power assembly 100 may, in another aspect of the invention that is capable of independent use, includes a bent construction having a first portion 110 including a stationary contact 111, a second portion 112 that is bent from the first portion 110 by bend 114, which may be a bend angle 114A of between about 80 degrees and about 135 degrees, or even between about 93 degrees and about 135 degrees. The bend 114 further reduces a number of bends of the relatively large diameter line conductor 106.

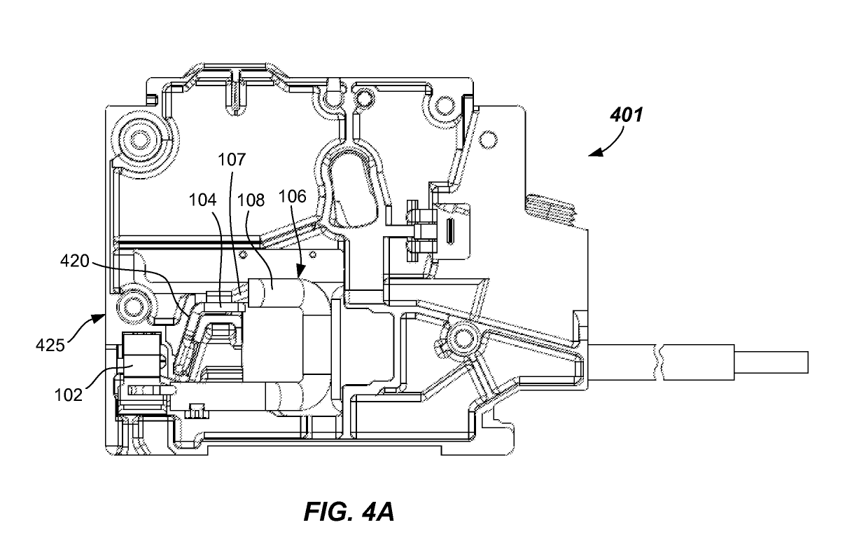

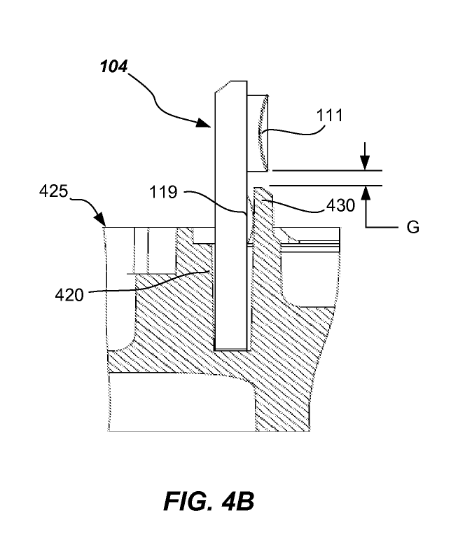

The stationary contact terminal 104 may include a line tab 116 configured to attach the conductor 107 of the line conductor 106. In another feature of the stationary contact terminal 104 including bent construction, the stationary contact terminal 104 further comprises an L-shaped insert 118. L-shaped insert 118 is configured to be received in a pocket 420 in the housing 425, which may also include an L-shape. Circuit breaker line power assembly 100 may be included in the circuit breaker 401 as shown in FIG. 4.

The stationary contact terminal 104, as best shown in FIGS. 1A-1B and 1F, may include a raised portion 119 such as a round dimple on the first portion 110. Raised portion 119 may be raised up above the remaining portion of the first portion 110, such as by about 0.015 inch (about 0.38 mm), and may be formed by stamping. Raised portion 119, as best shown in FIG. 4B, may be used to secure the stationary contact terminal 104 into the pocket 420 of the housing 425, which may include a molding draft angle thereon. An inside surface of the pocket 420 is contacted by the raised portion 119 to support the stationary contact 111 and prevent movement thereof.

Housing 425 may include an arc blocking portion 430 that, when the stationary contact terminal 104 is fully seated in the pocket 420, extends into close proximity (e.g., within a gap distance (G) about 0.08 inch (about 2.0 mm) or less, or even a gap distance (G) about 0.04 inch (about 1.0 mm) or less) from the stationary contact 111. Arc blocking portion 430 may prevent damage to the stationary contact terminal 104.

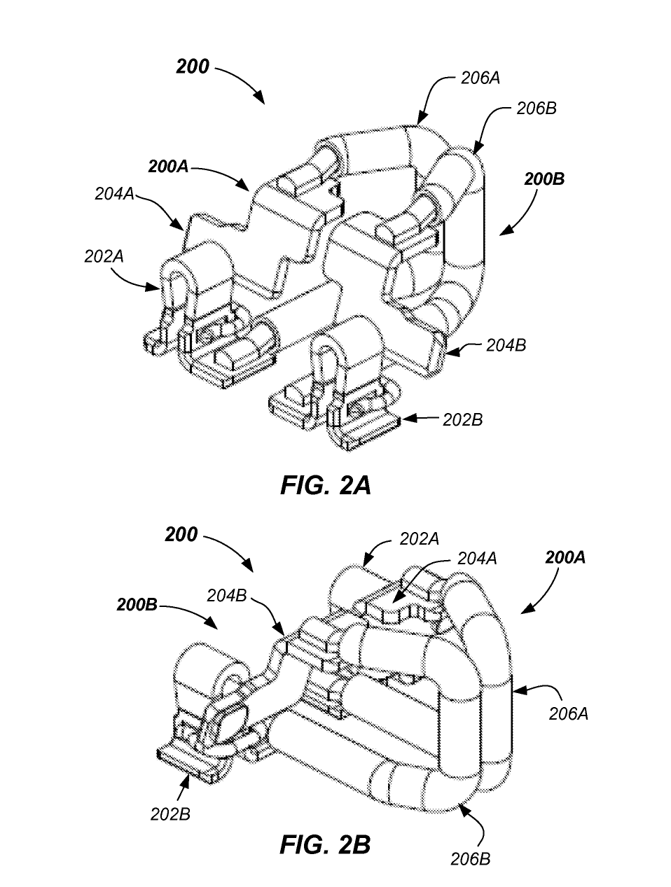

Now referring to FIGS. 2A and 2B, an arrangement of circuit breaker line power assembly 200 comprising a first circuit breaker line power assembly 200A that is identical to circuit breaker line power assembly 100 as previously described, and a second circuit breaker line power assembly 200B, which is essentially a mirror image of the first circuit breaker line power assembly 200A is shown and described. The first circuit breaker line power assembly 200A includes a first stationary contact terminal 204A, a first line terminal 202A, and a first line conductor 206A extending from the first line terminal 202A to the first stationary contact terminal 204A, wherein the first line conductor 206A comprises braided strand construction. The second circuit breaker line power assembly 200B includes a second stationary contact terminal 204B, a second line terminal 202B, and a second line conductor 206B extending from the second line terminal 202B to the second stationary contact terminal 204B, wherein the second line conductor 206B comprises braided strand construction. One or more current transducers may encircle parts of one or both of the first line conductor 206A and the second line conductor 206B.

FIG. 4A illustrates a side plan view of a portion of an embodiment of circuit breaker 401 including a circuit breaker line power assembly 100. Circuit breaker 401 may include a housing 425, which may be molded case housing made from a suitable plastic material, for example. The material may be a thermoset material, such as a glass-filled polyester, or a thermoplastic material such as a Nylon material (e.g., Nylon 6), for example. Other suitable housing materials may be used. Housing 425 may include a pocket 420 formed therein. Pocket 420 may include an L-shaped configuration configured to receive the L-shaped insert 118. The angle of the L-shaped configuration of the pocket 420 may be between about 80 degrees and about 130 degrees. Other non-180 degree angles may be used.

The housing 425 may be made up of any number of interconnecting housing sections (only one side section shown). For example, two halves may be connected together to form an internal cavity for receiving the circuit breaker line power assembly 100 as well as the other conventional circuit breaker components. Conventional circuit breaker components include a load terminal, load conductor, bimetal assembly including bimetal element and cooperating magnetizible element, latch, cradle, moveable contact arm, bimetal to moveable contact arm conductor, and circuit breaker handle, which are entirely conventional and will not be explained in further detail. Other conventional components may be included.

Circuit breaker 401 further includes the circuit breaker line power assembly 100 as previously described, including a line terminal 102, a stationary contact terminal 104 received in the pocket 420, and a line conductor 106 extending from the line terminal 102 to the stationary contact terminal 104, wherein the line conductor 106 comprises a conductor 107 including braided strand construction, and may include woven insulation 108.

In the case where the circuit breaker is a 2-pole circuit breaker, the circuit breaker line power assembly 200, 300, as best shown in FIGS. 2A, 2B, 3A, and 3B, may include a second circuit breaker line power assembly 200B, 300B that may include a second line terminal 202B, 302B, a second stationary contact terminal 204B, 304B, and a second line conductor 206B, 306B extending from the second line terminal 202B, 302B to the second stationary contact terminal 204B, 304B, and wherein the second line conductor 206B, 306B comprises braided strand construction.

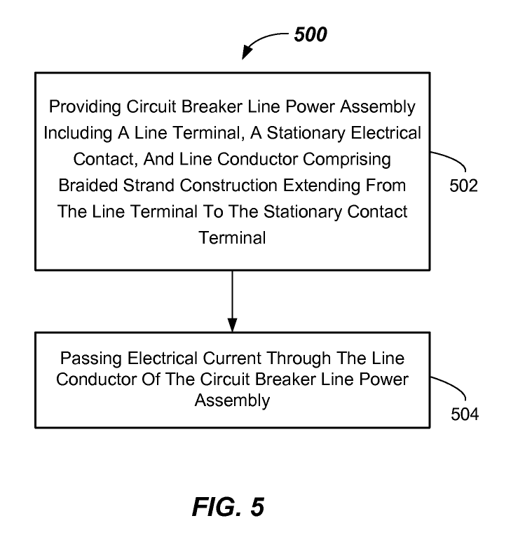

According to another aspect, a method of operating a circuit breaker line power assembly is provided. As shown in FIG. 5, the method 500 includes, in 502, providing circuit breaker line power assembly (e.g., circuit breaker line power assembly 100, 200A, 200B, 300A, 300B) including a line terminal (e.g., line terminal 102, 202A, 202B, 302A, 302B), a stationary contact terminal (e.g., stationary contact terminal 104, 204A, 204B, 304A, 304B), and line conductor (e.g., line conductor 106, 206A, 206B, 306A, 306B) comprising braided strand construction extending from the line terminal to the stationary contact terminal, and, in 504, passing electrical current (e.g., an electrical current of between about 32 A to about 120 A during operation) through the line conductor of the circuit breaker line power assembly.

While the invention is susceptible to various modifications and alternative forms, specific embodiments and methods thereof have been shown by way of example in the drawings and are described in detail herein. It should be understood, however, that it is not intended to limit the invention to the particular apparatus, systems or methods disclosed, but, to the contrary, the intention is to cover all modifications, equivalents and alternatives falling within the scope of the invention.

What is claimed is:

1. A circuit breaker line power assembly, comprising:
a line terminal;
a stationary contact terminal; and
a line conductor extending from the line terminal to the stationary contact terminal, wherein the line conductor comprises braided strand construction.

2. The circuit breaker line power assembly of claim 1, wherein the line conductor comprises a woven fiberglass insulating sleeve.

3. The circuit breaker line power assembly of claim 1, wherein the line conductor comprises an acrylic-coated woven fiberglass insulating sleeve.

4. The circuit breaker line power assembly of claim 1, wherein the braided strand construction comprises copper wire strands, wherein each of the copper wire strands has a diameter of greater than about 0.0015 inch.

5. The circuit breaker line power assembly of claim 4, wherein the braided strand construction comprises copper wire strands, wherein each of the copper wire strands has a diameter of between about 0.0015 inch and about 0.0025 inch.

6. The circuit breaker line power assembly of claim 1, wherein the braided strand construction comprises greater than about 1500 wire strands.

7. The circuit breaker line power assembly of claim 6, wherein the braided strand construction comprises greater than 2000 wire strands.

8. The circuit breaker line power assembly of claim 1, wherein the braided strand construction comprises between about 1500 wire strands and about 2500 wire strands.

9. The circuit breaker line power assembly of claim 1, wherein the braided strand construction comprises greater than about 1500 copper wire strands wherein each of the copper wire strands has a diameter of greater than about 0.0015 inch, and a conductor has an overall conductor diameter of greater than about 0.125 inch.

10. The circuit breaker line power assembly of claim 1, wherein the braided strand construction comprises between about 1500 wire strands and about 2500 wire strands of copper wire, each of the wire strands having a diameter of between about 0.0015 inch and about 0.0025 inch, and an overall conductor diameter of a conductor of greater than 0.125 inch and less than 0.150 inch.

11. The circuit breaker line power assembly of claim 1, wherein a conductor of the line conductor comprises a combination of the braided strand construction and twisted construction.

12. The circuit breaker line power assembly of claim 1, wherein the line terminal comprises a c-clip.

13. The circuit breaker line power assembly of claim 1, wherein the line terminal comprises a bolt on terminal connector.

14. The circuit breaker line power assembly of claim 1, wherein the stationary contact terminal comprises:
a first portion including a stationary contact terminal, a second portion bent from the first portion and including a line tab configured to attach the line conductor.

15. The circuit breaker line power assembly of claim 14, wherein the stationary contact terminal further comprises an L-shaped insert.

16. The circuit breaker line power assembly of claim 14, wherein the stationary contact terminal further comprises a raised portion on the first portion.

17. The circuit breaker line power assembly of claim 1, comprising a second line terminal, a second stationary contact terminal, and a second line conductor extending from the second line terminal to the second stationary contact terminal, wherein the second line conductor comprises braided strand construction.

18. A circuit breaker, comprising:
a housing including a pocket; and
circuit breaker line power assembly including:
a line terminal,
a stationary contact terminal received in the pocket, and
a line conductor extending from the line terminal to the stationary contact terminal, wherein the line conductor comprises braided strand construction.

19. The circuit breaker of claim 18, comprising a second line terminal, a second stationary contact terminal, and a second line conductor extending from the second line terminal to the second stationary contact terminal, wherein the second line conductor comprises braided strand construction.

20. A method of operating a circuit breaker line power assembly, comprising:
providing circuit breaker line power assembly including a line terminal, a stationary contact terminal, and line conductor comprising braided strand construction extending from the line terminal to the stationary contact terminal; and
passing electrical current through the line conductor of the circuit breaker line power assembly.
